(19) United States
(12) Patent Application Publication
(10) Pub. No.: US 2014/0208194 A1
(43) Pub. Date: Jul. 24, 2014

(54) DEVICE AND SYSTEM FOR SECURELY EXECUTING ELECTRONIC DOCUMENTS

(71) Applicants: Michael O'Leary, Chicago, IL (US); Michael Hansen, Whitefish Bay, WI (US); Matthew Murray, Chicago, IL (US)

(72) Inventors: Michael O'Leary, Chicago, IL (US); Michael Hansen, Whitefish Bay, WI (US); Matthew Murray, Chicago, IL (US)

(21) Appl. No.: 14/159,827

(22) Filed: Jan. 21, 2014

Related U.S. Application Data
(60) Provisional application No. 61/755,139, filed on Jan. 22, 2013.
(60) Provisional application No. 61/771,894, filed on Mar. 3, 2013.

(51) Int. Cl. G06F 17/24; G06F 17/21

(52) U.S. Cl. CPC G06F 17/243; G06F 17/211
USPC 715/222

(57) ABSTRACT

A system and method for creating and/or presenting electronic forms to users and securely collecting the data entered into the electronic forms. A dashboard application includes a collection of electronic forms for display on a presentation device. Clients complete their corresponding form(s) through the presentation device and the completed form(s) are collected by a server application and stored in a database remote from the presentation device.

### CROSS REFERENCE TO RELATED APPLICATIONS

This application claims the benefit of U.S. Provisional Patent Application Ser. No. 61/755,139, filed on 22 Jan. 2013, and U.S. Provisional Patent Application Ser. No. 61/771,894, filed on 3 Mar. 2013. The co-pending provisional applications are hereby incorporated by reference herein in their entirety and are made a part hereof, including but not limited to those portions which specifically appear hereinafter.

### BACKGROUND OF THE INVENTION

The present subject matter relates generally to a system and method of presenting electronic forms to users and securely collecting the data entered into the electronic forms. More specifically, the present invention is a system and method for creating and securely sharing electronic forms, securely collecting the data entered into the forms, and providing a dashboard for controlling the creation, distribution, and collection of the forms.

There are numerous situations in which securely providing electronic forms and securely collecting data from the electronic forms may be beneficial. For example, one application is in the medical field, and specifically in client intake at a medical office. Using this example, the medical office may wish to provide one or more forms to the client relating to various personal and confidential data, including personal information, medical information, financial information, etc. Traditionally, these forms have been provided in paper form. Paper forms are inefficient in that the data collected must be converted into electronic form for storage as electronic documents. This may require OCR conversations, manual entry, or other processes that limit the efficiency of the system. In addition, the completeness and security of the forms may be compromised if a form is misplaced going to or coming from the patient. Electronic forms may be provided, but data security is a significant concern, particularly in situations in which data is transferred over networks such as wireless networks.

Ideally, collection of data from patients in a medical office would sync directly with the Electronic Medical Record software (EMR software) commonly used in medical offices. However, there are two main challenges with syncing with EMR software: (1) integration; and (2) security.

EMR software systems are typically very closed and either do not allow any communication with outside software components or make it very difficult to integrate outside software components into the EMR software. Additionally, there are numerous variations of EMR software in the market, which makes providing a standardized solution more complex. Integrating directly with each variation of EMR software may require an individual integration scheme. Such individualized integration would be costly and time-consuming and would not provide an easily scalable solution.

With respect to security, communication over wireless networks (which would be how electronic forms would most likely be distributed and collected in a medical office) is inherently a security risk. Wireless networks may be hacked and data can be intercepted. When personal, medical, and financial information is at risk, security issues are exceptionally important to address. One traditional “solution” to the security issue is to use a web server and serve up the forms via HTML. However, since the web server is a fixed target that remains up and running for extended periods of time, it is particularly susceptible to hacking attempts. A typical web server in this context will have fixed addresses and ports, making the web server an easy target. These security concerns make the implementation of electronic forms in a medical office setting a risky and unattractive option.

Of course there are countless other contexts in which the presentation of electronic forms and the secure collection of data from the forms may be valuable. For example, there are numerous financial contexts in which data security is exceptionally important, including banking, lending, real estate transactions, etc. Similarly, there are legal contexts in which the secure presentation of forms and collection of data therefrom is important, including the presentation of confidential information to a lawyer working on a sensitive matter, whether it may be related to taxes, trusts and estates, corporate governance, intellectual property, etc. Each of these varied contexts may suffer from one or more of the problems identified above, particularly the security issues are likely to be common to each context.

As shown, securely providing electronic forms and securely collecting the data acquired through those forms is a complex, but valuable, task. Accordingly, there is a need for a system and method for creating and securely sharing electronic forms, securely collecting the data entered into the forms, and providing a dashboard for controlling the creation, distribution, and collection of the forms, as described further herein.

### SUMMARY OF THE INVENTION

To meet the needs described above, the present invention provides a system and method for creating and securely sharing electronic forms, securely collecting the data entered into the forms, and providing a dashboard for controlling the creation, distribution, and collection of the forms. While the examples and embodiments described herein are primarily related to use in the medical office context, it is understood that the solutions provided herein may be broadly applicable across numerous contexts and situations.

One example of a system embodying the solutions provided herein includes: a form design application; a dashboard application; a set of APIs for building service-oriented architecture applications; a presentation device; a server; and a software component that receives the user inputs and communicates the user inputs to a host application through an integration solution. In one embodiment, the system includes a dashboard application executable on a personal computing device and including a collection of electronic forms stored in a database and capable of display, a presentation device including a user interface to display one or more of the forms, and a server application executable on a personal computing device to send and collect forms, such as via a virtual printer driver, between the dashboard application and the presentation device, wherein information collected through the presentation device is not stored on the presentation device.

The invention further includes a method of presenting electronic forms. The method can include: storing a plurality of user-generated electronic forms in a database associated with a personal computing device; displaying the stored electronic forms through a user interface dashboard for selection; sending a selected one or more electronic forms to a presentation device for display through a presentation device user interface; receiving form information entered via the presentation device; and storing the completed one or more electronic fours on a recordable medium associated with the personal computing device. The electronic forms can, and are desirably generated in a standard format, such as a Word document or a PDF document, using a form design application executable on a personal computing device.

Security is of utmost importance for many implementations of this invention, such as the collection of private medical information. In one embodiment, for security reasons, the server spawns a new and random or different web server every time a user works with the presentation device. Through a secure handshaking protocol between the presentation device and the server, each new web server has a random, unique connection or port number. When the user is finished filling out the forms the web server is shut down and is gone forever. The webserver can use HTTPS as the transport protocol to ensure a secure connection between the server and the presentation device. A specific certificate can be saved on both the server and the presentation device. HTTPS requires a certificate in order to allow communication between the server and the presentation device. A hacker would need to know the address being spawned as well as the port number (which randomly could number in the 10s of 1000s of random ports). This creates a very secure solution, and is also preferred in that there is no need to install a web server which can be a very daunting task even for an IT professional. Furthermore, as the web server makes a one-to-one connection, the connection of the presentation device can be immediately and automatically shut down upon the detection of more than one connection. The solution of this invention can also be installed on any Windows desktop and the agent can run the dashboard software to communicate forms to the presentation device.

This invention further allows for the important integration of third party applications, such as for linking the completed forms to the user's records. Electronic medical record software, for example, is typically closed and does not generally allow communication with outside software components. Another issue is the number of different medical record software systems available. In one embodiment of this invention, a TWAIN driver is used to bypass a major integration with third party applications, as most applications that input user forms with signatures and other user inputs already work with TWAIN drivers. The reason is that in the current workflow users fill out paper forms and these paper forms are then scanned with a sheet fed scanner. Third party applications thus already have a TWAIN integration method. The invention can include a TWAIN driver for the system that can integrate directly into third party applications with little integration effort. And since TWAIN supports PDF, PDF/A, and images as forms of output, the server component has been built so that it can output the user data in those formats.

Additional objects, advantages, and novel features of the examples will be set forth in part in the description which follows, and in part will become apparent to those skilled in the art upon examination of the following description and the accompanying drawings or may be learned by production or operation of the examples.

### BRIEF DESCRIPTION OF THE DRAWINGS

FIGS. 1 and 2 show a presentation device according to one embodiment of this invention.

FIG. 3 shows a presentation device dock according to one embodiment of this invention.

FIG. 4 shows the presentation device of FIGS. 1 and 2 in the dock of FIG. 3.

FIGS. 5 and 6 show a dock according to another embodiment of this invention.

FIGS. 7 and 8 show connectors for a presentation device and dock according to one embodiment of this invention.

FIG. 9 shows a dock according to another embodiment of this invention.

FIG. 10 shows a dock according to yet another embodiment of this invention.

FIG. 11 illustrates a user interface of a form design application according to one embodiment of this invention.

FIG. 12 illustrates an example of a dashboard application according to one embodiment of this invention.

FIG. 13 is a flow diagram of the dashboard application communicating with the server, according to one embodiment of this invention.

FIG. 14 is a flow diagram showing an exemplary architecture of the system according to one embodiment of this invention.

FIG. 15 is a functional flow chart for the systems and methods according to one embodiment of this invention.

FIG. 16 shows which software components reside on each hardware device.

### DESCRIPTION OF THE INVENTION

The invention includes a system for electronically presenting documents and/or forms (referred to herein collectively as “forms”) and electronically receiving information and/or signatures input on the presented forms. The system includes, without limitation, a presentation device, a form design software application for creating forms, a dashboard application for use in determining forms to be presented, and/or a server application to coordinate components of the system.

In one embodiment of this invention the system includes at least one data processor, such as a Windows based PC, and a presentation device, which can communicate to the data processor wirelessly or by wired connection. The presentation device includes a monitor, desirably a touchscreen, to display a graphical user interface. The presentation device is desirably a tablet computer device, such as an iPad®, or Android® tablet device, such as a Samsung Galaxy®, but can also be other devices, such as a kiosk or a touchscreen connected to a desktop computer. Existing tablet devices can be modified as needed to provide aspects and features of this invention described below.

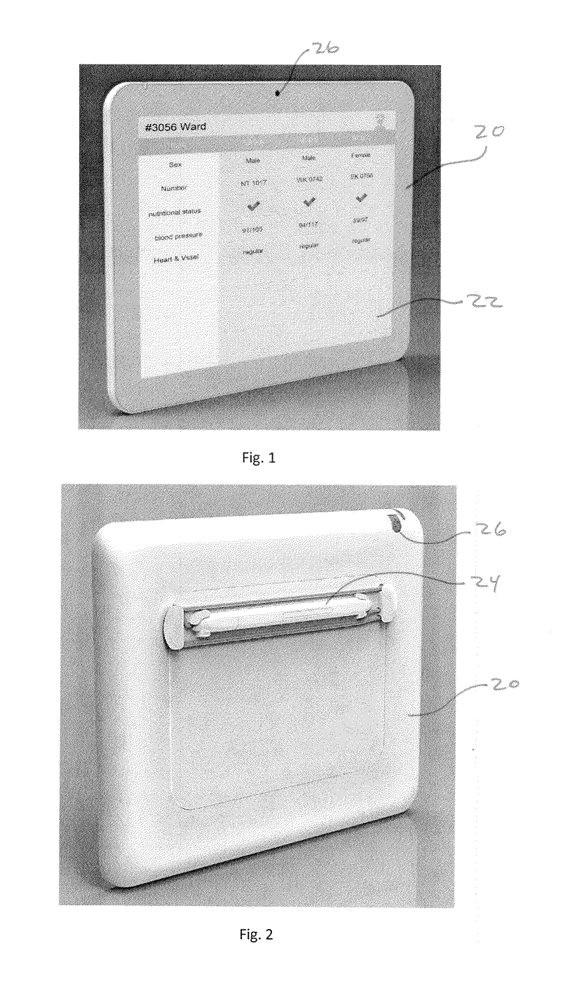

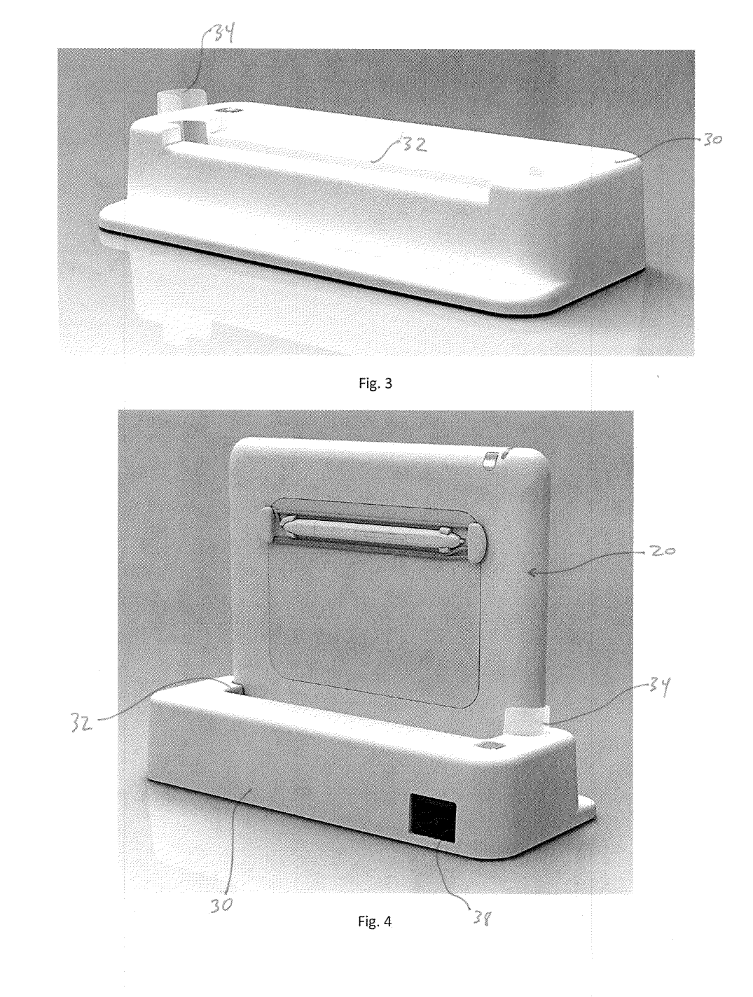

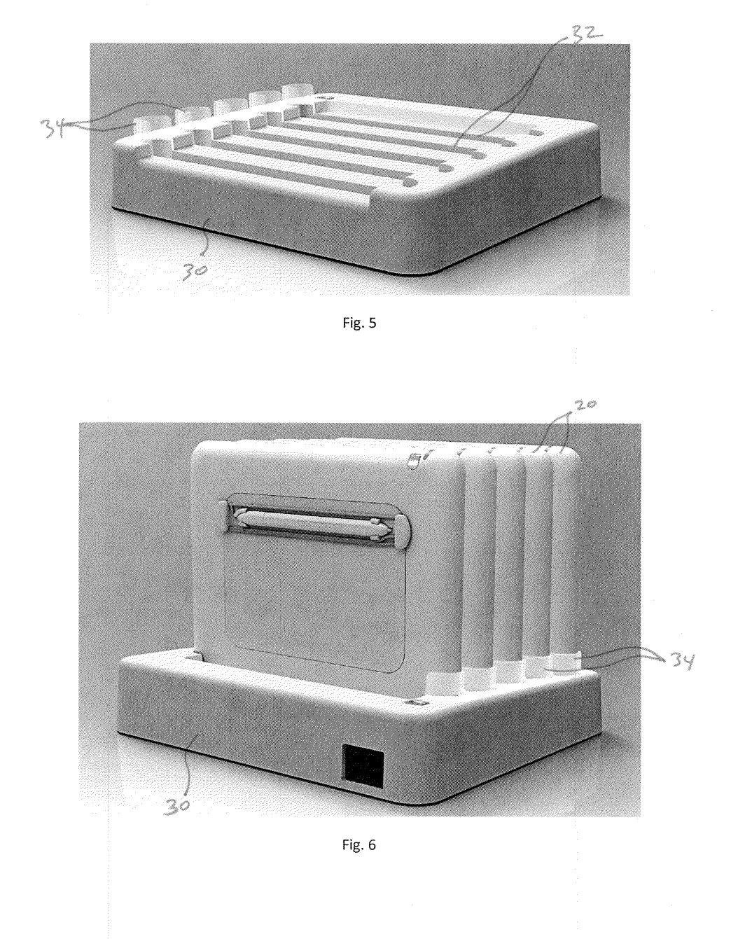

FIGS. 1 and 2 illustrate a tablet presentation device 20 according to one embodiment of this invention. The tablet will also include a docking station 30 that provides for charging the tablet 20 as well as storing the tablet 20 when it is not in use. FIGS. 3 and 5 illustrate tablet docking stations 30 according to embodiments of this invention, and FIGS. 4 and 6 show tablets 20 within the docking stations 30.

Referring to FIG. 1, the tablet desirably includes a touchscreen panel 22 that allows finger and/or stylus input. Stylus input can desirably not only report x/y coordinates, but pressure as well. Pressure feedback can be used for biometric data that identifies a user applying a signature to the form. In one embodiment, a capacitive touch panel is applied to the front of the LCD for finger input, and an EM type panel is applied to the rear of the LCD to acquire data from the stylus 24, including x/y and pressure feedback. The EM panel used for stylus input can be an ERT type, such as provided by Hanvon and/or Wacom.

In one embodiment of this invention, the only non-volatile memory on the tablet is to house the operating system and custom applications for the device. The tablet does not include a hard drive or similar memory component to store any form or user inputs, in order to ensure that user data is not persisted on the tablet. If a tablet were stolen or hacked this would provide a security issue, and thus no hard drive is included with the device. The motherboard can include a dual core processor, and can run a Marvell specific version of the Android operating system, referred to as “Ice Cream Sandwich” (ICS).

The tablet can be any suitable size, shape, and configuration. The LCD desirably has 4:3 aspect ratio. Most tablets today use a 16:9 wide aspect ratio, but 4:3 is a much more natural aspect ratio for the principle application of this device, namely the presentation of forms. The tablet mimics paper and clipboard, and thus a 4:3 aspect ratio mimics quite well the aspect ratio of an 8.5″×11″ sheet of paper. A 10.1″ diagonal, 1024×768 pixel display is one particularly preferred screen type.

The outside of the tablet enclosure may be manufactured with anti-microbial plastics to minimize the transmittance of disease. One major market for the device is healthcare, and thus it is important to minimize the risk of transmittance of disease and viruses. The tablet can have a rubberized backing, such as where the user's fingers come in contact with the tablet. This is to avoid the occurrence of the tablet slipping out of the hands as well as giving it a soft feel.

The stylus 24 can be tethered to the tablet 20 as shown in FIG. 2, so that it cannot be lost. Most tablets on the market today have a removable and easily lost stylus. The stylus is a relatively expensive part of the design in that it can include active electronics.

An option port can be included on the tablet to receive optional items such as, without limitation, a magnetic strip reader for reading credit cards. The option port can be a USB port, but may use a non-standard connector, and may be completely shielded so that it is not externally available. The reason for shielding the connector is to avoid any hacking of the device and stealing user data.

The tablet uses a wireless connection to connect to networks. It is capable of connecting to the commonly available wireless network types available today.

A front and/or back facing camera 26 is included to optionally obtain a picture of the user after signing a form. A date/time stamped image of the user during signing the document would provide an extra layer of proof of the signee. The camera can also read barcodes on standard IDs such as driver's licenses. The camera can also be used as an OCR scanner for a standard ID document such as a driver's license. This could be used to verify an individual or pre-populate a form. The camera can be any suitable tablet camera, such as a 5 MP CMOS type camera with autofocus. A speaker and microphone can also be included.

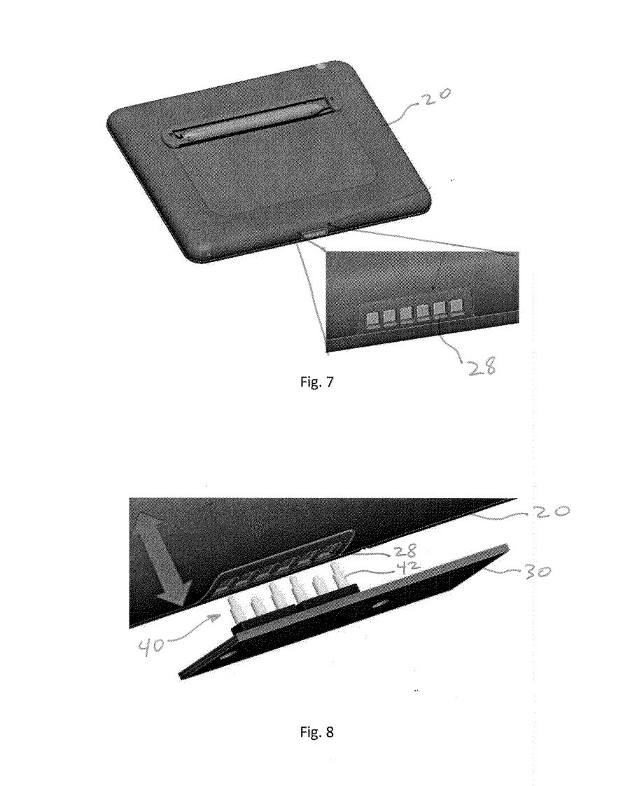

The docking station, or “dock”, is used to charge the tablet. The dock can include a wireless or wired connection to the server and/or tablet, and functions primarily for holding and charging one or more tablets. Most current commercial tablet devices have a wall cable connector for charging the device. This is unwieldy to use in a high throughput environment like a healthcare facility. With the dock 30 of FIGS. 3, 4, and 6, the tablet 20 can simply be set within a slot 32 of the dock 30 and automatically start charging. Within the slot 32 is a connector for charging the tablet 20. Any suitable connector for transmitting electrical power can be used. In one embodiment, shown in FIGS. 7 and 8, the docks 30 include a connector 40 having biased connector pins 42, such as pogo pins or connectors, to reliably make the connection. Pogo style pins commonly include a slender cylinder containing two spring-loaded pins. Pressed between two electronic circuits, the points at each end of the pogo pin make a secure contact with the two circuits and thereby connect them together. As shown in FIGS. 7 and 8, the connector 40 includes pins 42 for charging and communicating status with the corresponding contact charging points 28 of the tablet 20.

The dock 30 is preferably slotted in such a way so that the tablet 20 cannot be inserted backwards. The dock 30 includes a charging unit for charging the battery on the tablet. It also includes a microprocessor to communicate charging information to the tablet. The dock shown in FIGS. 3, 4, and 6 includes a clear plastic (acrylic) lens 34 extending above one side of the dock top surface. The lens can include LED indicator lights of one or more color to indicate messages such as charging or proper seating, charged, or error.

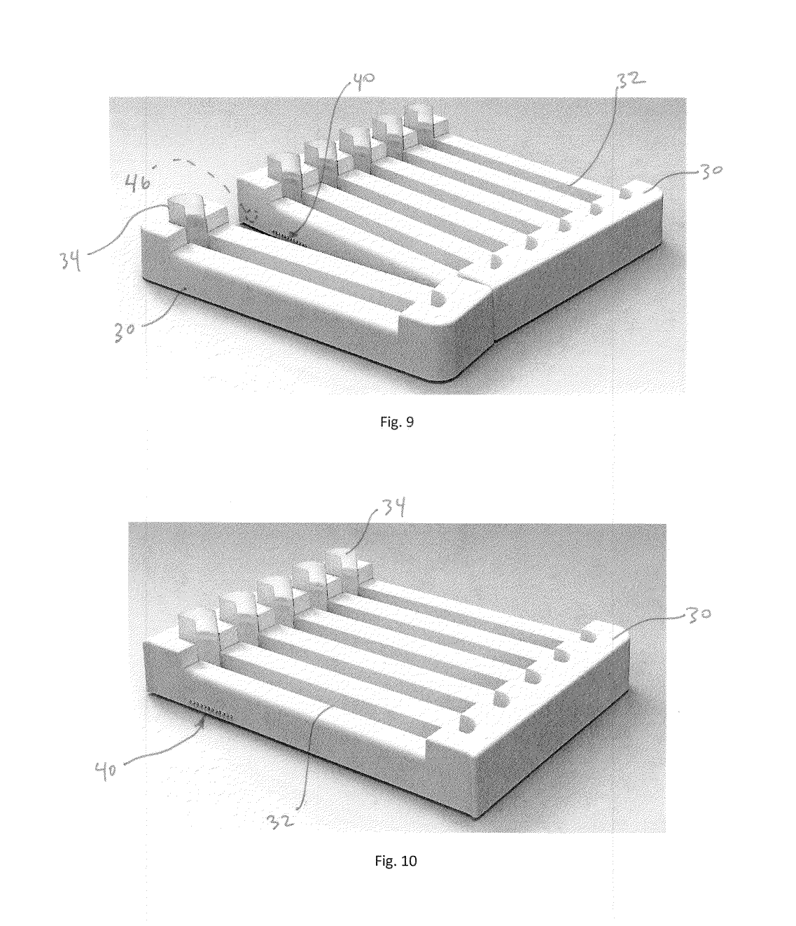

FIG. 3 shows a single tablet dock 30, while FIG. 5 shows an alternative multi-tablet dock. In one embodiment, the dock is also designed in such a way that docks can be connected together so that a customer can purchase one tablet/dock and then add multiple docks, attaching/ganging the docks together. The docks are connected mechanically and/or magnetically and/or electrically, such that each dock does not need to be separately plugged into an electrical outlet. When connected, one dock 30 includes the power cord connector 38 that connects by a power cord to both 115 VAC, 60 Hz and 220/240 VAC, 50 Hz wall power outlets. Any suitable connector can be used to connect multiple docks. In one embodiment, such as illustrated in FIG. 9, rare earth magnets 46 embedded within or behind the plastic body of the dock 30 can be used to connect adjacent docks, via corresponding rare earth metals and/or metal elements. Other alternatives, such as coordinating hook-like elements or upward facing tabs that fit into downward facing recesses of a second dock, can also be used. Pogo connectors, such as described above, can be used as electrical connectors, such as shown in FIGS. 9 and 10. Any other suitable male/female mechanical and/or electrical connectors can be used to combine adjacent docks.

One preferred use of the tablet is to display forms for review and acceptance or execution by a user, such as medical documents for a patient. In one embodiment, the invention includes software for creating or designing the forms for display on the tablet. One example of a system embodying the solutions provided herein includes: a form design application; a dashboard application; a set of APIs for building service-oriented architecture applications; a presentation device; a server; and a software component that receives the user inputs and communicates the user inputs to a host application through an integration solution. The elements and processes of the exemplary system are provided in further detail below.

In one embodiment, the form design application is a software application resident on a personal computing device (desktop, laptop, tablet computer, other mobile device, etc.) through which an agent can create customized electronic forms. The forms created in the form design application may then be securely packaged by the application to be hosted on the server. In an exemplary embodiment, the form design application enables the agent to create electronic forms including any combination of various elements such as, for example, headers, checkboxes, radio boxes, edit boxes, combo boxes, images, multimedia content, signature forms, etc. Such software may be provided in any known form as will be recognized by those skilled in the art based on the disclosures provided herein.

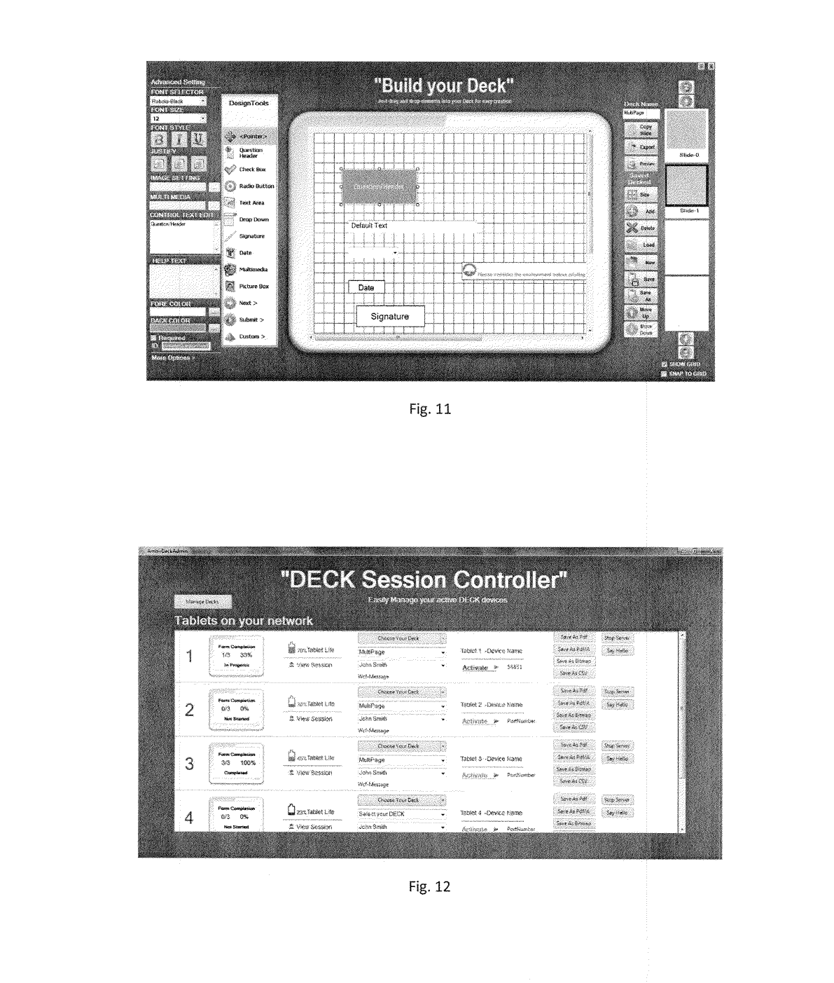

In one presently preferred embodiment, the form design application is a design utility provided in the WYSIWYG format such that users can create and edit forms. For example, the form design application may include one or more control panels and a form-building template. An example of a form design application is shown in FIG. 11. As shown, the left and right panels include the tools for designing and saving the form. Such tools include tools for customizing all aspects of the text, colors, input tools, etc. A new form may be created by dragging and dropping elements to be included in the form from the tool panels to the template, arranging the elements within the template, editing the attributes of the elements using the tools provided, and then saving the completed form. This embodiment of the form design application is a Microsoft Windows Forms application developed in C#. However, while the form design application is provided for illustrative purposes, it is contemplated that there are numerous manners and embodiments in which the form design application may be expressed.

Further, in this example, the form design application is used to construct forms that that are then sent to the one or more presentation devices in the HTML5 markup language. To facilitate security and to maintain proprietary control of the forms created, the forms are encrypted in a proprietary format. This prevents the forms from being used or decompiled in other systems.

The dashboard application is the platform through which the agent chooses electronic forms to distribute to a user. In a preferred embodiment, the dashboard application is the application through which the agent further administers one or more presentation devices. In such embodiments, the dashboard application may provide the agent with controls and notifications related to: the status of one or more presentation devices on the network; the battery power available in each of the presentation devices (if the devices are portable); and the status of the user's progress in completing the form on the associated presentation device. In use, the dashboard application enables the agent to select one or more forms created by the form design application (or input from another source, such as a third-party form distributor) and select the one or more presentation devices to which to deliver the selected forms. The forms are sent through the dashboard application by communicating though the set of APIs which, in turn, communicate with the server to transmit the forms to the selected one or more presentation devices. The operation of this communication is described in greater detail below.

FIG. 12 illustrates an example of a dashboard application according to one embodiment of this invention. As shown, this embodiment of the dashboard application shows the “tablets on your network,” the form completion status for each tablet, the present battery life for each tablet, and forms distributed to each tablet. Like the form design application above, the dashboard application is a Microsoft Windows Forms application developed in C#. However, it is contemplated that there are numerous manners and embodiments in which the dashboard application may be expressed.

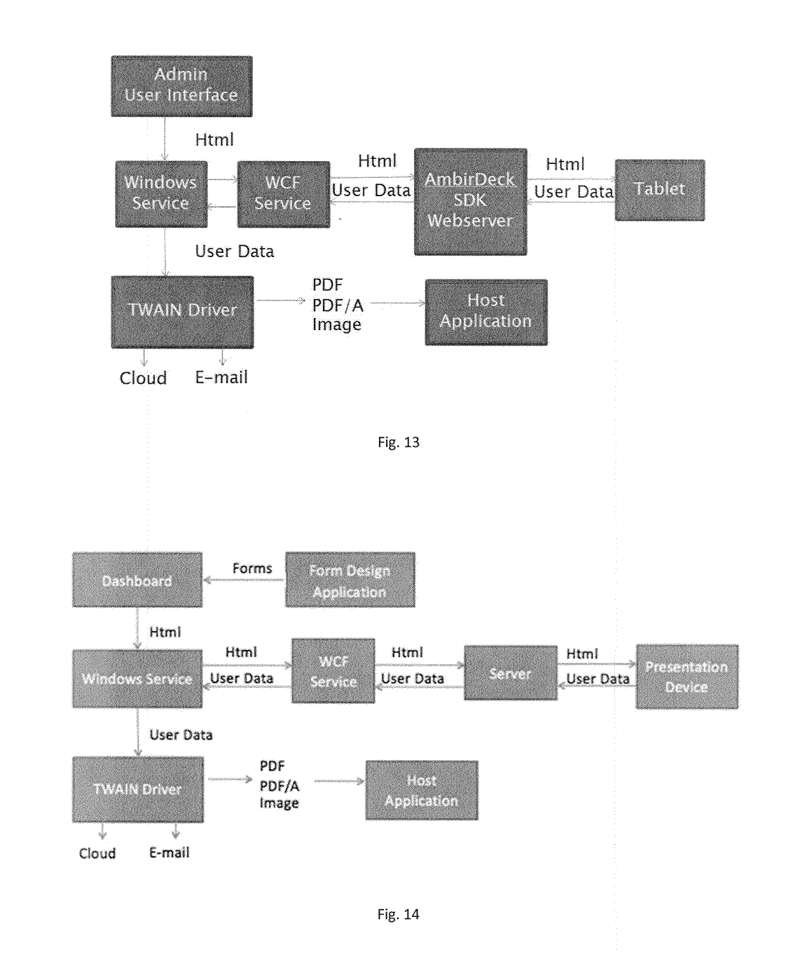

As noted above, the forms are sent through the dashboard application by communicating though the set of APIs which, in turn, communicate with the server to transmit the forms to the selected one or more presentation devices. In the examples shown, the dashboard application communicates with the server through a Windows Communication Foundation service (WCF service), such as shown in FIG. 13, which is one example of a set of APIs for building service-oriented architecture applications. Alternatively, another set of APIs may be provided to enable the dashboard application to communicate with the server, as will be recognized by those skilled in the art based on the disclosures provided herein.

The purpose of the WCF service (or other set of APIs) is essentially that of a routing component. Because the server can only communicate with one component, the WCF service is inserted between the dashboard application and the integration solution (described further below) on one side and the server on the other. The WCF service is wrapped in a traditional Windows service to enable it to communicate with more than one service at a time. Accordingly, both the dashboard application and the integration solution may communicate with the WCF service and the server. In other words, the WCF service (and associated Windows service) is pass-through layer that simply wraps the server to give the server a single interface with which to communicate, which then in turn enables the server to communicate with more than one component.

The one or more presentation devices may be provided in any convenient form, including tablet computers, other mobile devices, dedicated kiosks, etc., such as described above. The one or more presentation devices may be network enabled such that they communicate with the server via Wi-Fi or any other communications protocol as will be understood by those skilled in the art based on the disclosure provided herein. The presently preferred embodiment for the one or more presentation devices is an Android-based tablet computer optimized for use in the system, such as described above.

The one or more presentation devices receive the forms that have been selected for delivery through the dashboard application from the server. The data entered into the one or more presentation devices is then communicated back to the server, which routes the data through the integration solution to the host application (e.g., the EMR software). In one example of the integration solution provided by the disclosure herein, a virtual printer driver and/or a TWAIN driver is used to regulate the communication between the server and the host application. Similarly, another integration solution may be provided that uses another form of API to regulate the communication between the server and the host application. In a preferred embodiment, a TWAIN driver is used because it is typical for EMR software to use the TWAIN protocol to communicate with scanners, which commonly used in medical offices. In fact, there is an incredibly large body of applications today that can host drivers and accept images, PDF, and PDF/A files through use of TWAIN drivers.

As described, the server is the central component in the communication of the electronic forms, as well as the collection of the data received from those forms. The server is the heavy lifter in the systems and methods provided herein and its functionality is described in further detail as follows.

One task of the server is to identify the presentation devices that are on the network. This information is derived from the presentation devices that are in communication with the server and then communicated to the dashboard application. Through the information collected by the server, the server is able to identify and communicate the battery state of each presentation device to the dashboard application. Similarly, the completion status of the forms on each presentation device may be identified by the server and communicated to the dashboard application. Those skilled in the art will recognize additional data sets may be collected and communicated by the server based on the descriptions provided herein. The server also can provide and allow a query functionality for searching entered and stored user information and/or forms, and can display search results, for example, in a browser window.

One of the critical functions of the server is with respect to the secure communication between the server and the presentation devices. Because this communication is commonly performed in a wireless environment, the security of the communication is a paramount concern. In one example, the server uses a CHAP (Challenge-Handshake Authentication Protocol) and an SLP (Service Location Protocol) to find the presentation devices on the network and to authenticate the communication with the presentation devices. Through the CHAP and SLP, the server negotiates with the presentation device and provides the presentation device with the URL to access the HTML5 forms that the agent has selected to be sent via the dashboard application. The server then spawns a unique, temporary, web server to serve up the HTML5 forms to the specific presentation device. A unique web server is created each time forms are communicated to a presentation device. The web server is created with a random, unique port number each time it is spawned, as well as a random unique URL. This is an effective security measure against would-be hackers that would need to discover both the random unique port number and the random unique URL in the short time the temporary web server is in use. When the user completes the forms and the information has been communicated back to the server, the web server is shut down and gone forever.

In a presently preferred example, the web server uses HTTPS as the transport protocol to ensure a secure connection between the server and the presentation device. A system specific certificate is saved on both the server and the presentation device and the HTTPS requires the certificate in order to allow communication between the server and the presentation device.

The use of the temporary, unique, and secure web server created a highly secure environment in which the server and presentation device may communicate. Because of the transitory nature of the web server, it is not a fixed, stationary target to be hacked. Instead, each communication from the server to another presentation device creates a new temporary target.

Once the temporary web server is established, the server communicated the selected forms to the selected presentation device. In one example, a standard web browser is used to display the forms on the presentation device. However, it is contemplated that a dedicated application may be provided for receiving and displaying the forms to the user. The server then acquires the data input into the forms and exports that data to the host application. As described above, a TWAIN driver or similar integration solution may be provided to translate the data collected by the server into an appropriate format to be received by the host application. For example, the integration solution may provide the data to the host application is any of the following formats: a PDF; a PDF/A; an image file, such as a JPG; a CSV file; etc.

In addition, the server is capable of communicating all the metadata associated with the user inputs in a machine-readable format. This enables the data to be routed to a database or other data collection/presentation source. Because a TWAIN driver typically sends the user inputs back to the host application as a simple image, you lose all the metadata/user inputs. In cases where the metadata is desired, the server may be integrated with the host application and a mechanism in the software may be employed to extract all of the user inputs as strings to be communicated to the host application.

As described above, the integration solution is provided to enable seamless automated communication of the data input in the presentation device to the host application. The preferred embodiment uses a TWAIN driver because most host applications that receive user forms with signatures accept inputs that work with TWAIN drivers. The reason is that the workflow that was typical prior to the implementation of the solutions provided herein was for the user to complete one or more paper forms, scan the paper forms using a sheet fed scanner, and communicate the scanned data to the host application (e.g., EMR software) through a TWAIN driver. Using a TWAIN driver in the systems and methods provided herein enables instant integration with literally thousands of host applications in the market.

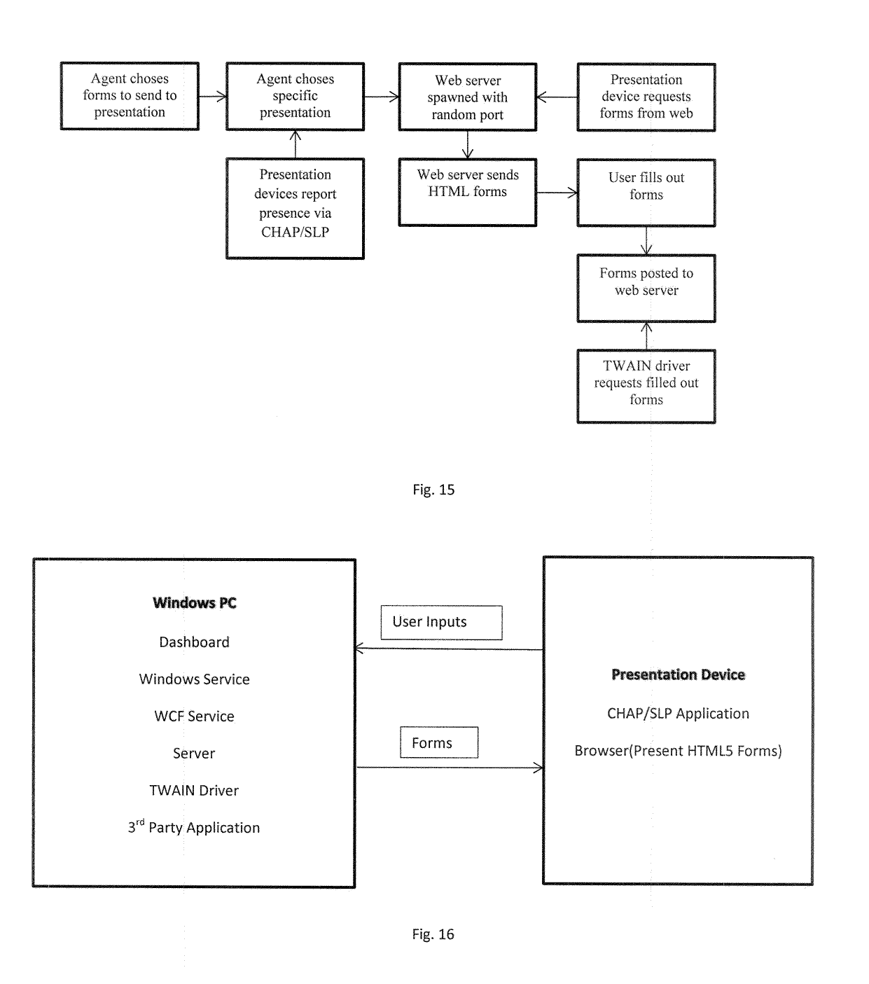

In the example used to illustrate the solutions provided herein, the TWAIN driver is built with unmanaged C++. Because unmanaged C++ cannot communicate directly with a WCF service, an intermediary component has been created in managed C++. The intermediary component's job is simply to pass data back and forth between the WCF service and the TWAIN driver. An example of the architecture of the system described herein is shown in FIG. 14. Further, a functional flow chart of for the systems and methods described herein is shown in FIG. 15.

There are two pieces of hardware to make the systems and methods function as described herein: (1) a Windows based PC; and (2) an Android based tablet (presentation device). FIG. 16 shows which software components reside on each hardware device. Of course it is understood that the hardware and software solutions provided herein may be incorporated into systems including a greater or lesser number of hardware components and the software components may be divided over the hardware in other configurations.

Further, while described as distinct components for purposes of clarity in the disclosure, it is recognized that any combination of the form design application, the dashboard application, the integration solution, and the host application may be integrated within a single software solution. However, it is further recognized that the most common grouping may be to provide the form design application, the dashboard application, and the integration solution in a single software platform that enables the communication of the data collected in the electronic forms into a distinct EMR software platform.

Further, while described above with reference to a specific medical office type application, the solutions provided herein may be adapted for broader application in various contexts.

Thus the invention provides a secure communication platform through which an agent may provide forms to be served to a user whose sensitive data may be collected and communicated to a host application. The present invention also provides a temporary secure web server for each set of communications between the server and the presentation device, which limits the risk of security breach by avoiding having a fixed web server whose integrity may be more easily attacked. Yet another advantage of the present invention is that it provides an integration solution that enables the systems and methods provided herein to instantly integrate with a large number of existing host applications.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A system for presenting electronic forms, the system comprising:
a dashboard application executable on a personal computing device and including a collection of electronic forms stored in a database and capable of display;
a presentation device including a user interface to display one or more of the forms; and
a server application executable on a personal computing device to send and collect forms between the dashboard application and the presentation device, wherein information collected through the presentation device is not stored on the presentation device.

2. The system of claim 1, wherein the server application comprises a virtual printer driver to send the forms to the presentation device.

3. The system of claim 1, further comprising a form design application executable on a personal computing device to create and edit the forms.

4. The system of claim 3, wherein the form design application executes on the personal computing device to display on a user interface a form-building template and a form design control panel.

5. The system of claim 3, wherein the dashboard application displays the forms created by the form design application upon selection of one or more of the forms.

6. The system of claim 1, further comprising a TWAIN driver to integrate completed electronic forms received from the presentation device with a form storage application.

7. The system of claim 1, wherein the dashboard application automatically monitors the form completion level on the presentation device.

8. The system of claim 1, further comprising a plurality of presentation devices, wherein the dashboard application automatically monitors and displays a status of each of the presentation devices.

9. The system of claim 1, wherein the presentation device comprises a tablet computing device.

10. The system of claim 9, wherein the presentation device comprises a stylus to fill out forms displayed on the tablet computing device.

11. The system of claim 1, further comprising a docking station including a plurality of docking ports for a plurality of presentation devices.

12. A method of presenting electronic forms, comprising:
storing a plurality of user-generated electronic forms in a database associated with a personal computing device;
displaying the stored electronic forms through a user interface dashboard for selection;
sending a selected one or more electronic forms to a presentation device for display through a presentation device user interface;
receiving form information entered via the presentation device; and
storing the completed one or more electronic forms on a recordable medium associated with the personal computing device.

13. The method of claim 12, further comprising generating custom electronic forms in a standard format using a form design application executable on a personal computing device.

14. The method of claim 12, further comprising receiving a selection of the one or more electronic forms through the user interface dashboard.

15. The method of claim 12, wherein the presentation device comprises a tablet computing device and a stylus adapted to fill out electronic forms displayed on the tablet computing device.

16. The method of claim 12, further comprising generating a different web server for each sending of the electronic forms to the presentation device.

17. The method of claim 16, wherein each different web server comprises a randomly selected one of a plurality of ports.

18. The method of claim 12, further comprising establishing a secure handshaking between a web server and the presentation device, wherein the secure handshaking includes providing a random URL with which the presentation device connects with the server.

19. The method of claim 18, further comprising shutting down a connection between the web server and the presentation device if more than one connection is made.

20. The method of claim 12, further comprising the dashboard monitoring and displaying a form completion level of the presentation device.

21. The method of claim 20, further comprising the dashboard application automatically monitoring and displaying a status of each of a plurality of presentation devices.

22. The method of claim 12, wherein the electronic forms are hosted and sent to the presentation device by a server, and further comprising automatically syncing the electronic forms with the server.
